(19) United States
(12) Patent Application Publication
(10) Pub. No.: US 2026/0170657 A1
(43) Pub. Date: Jun. 18, 2026

(54) METHOD AND APPARATUS FOR DETECTING ACID ETCHING SPEED OF CORE GLASS

(71) Applicants: CHINA BUILDING MATERIALS ACADEMY CO., LTD., Beijing (CN); China National Building Material Group Co., Ltd., Beijing (CN)

(72) Inventors: Ran Zhao, Beijing (CN); Yan Duan, Beijing (CN); Peng Jiao, Beijing (CN); Jing Ma, Beijing (CN); Rui Zhang, Beijing (CN); Danqi Zhao, Beijing (CN); Yuwen Xing, Beijing (CN); Bo Liu, Beijing (CN); Jinkai Zhao, Beijing (CN)

(73) Assignees: CHINA BUILDING MATERIALS ACADEMY CO., LTD., Beijing (CN); China National Building Material Group Co., Ltd., Beijing (CN)

(21) Appl. No.: 19/306,487

(22) Filed: Aug. 21, 2025

(30) Foreign Application Priority Data
Dec. 16, 2024 (CN) 202411851743.X

(51) Int. Cl. G06T 7/11; G06T 7/00; G06T 7/62

(52) U.S. Cl. CPC G06T 7/11; G06T 7/0004; G06T 7/62; G06T 2207/30108

(57) ABSTRACT

A method for detecting an acid etching speed of core glass includes obtaining an initial end face image and an acid-etched end face image sequence corresponding to a sample microchannel plate blank; selecting a plurality of target microholes in the initial end face image, and intercepting a microhole acid-etching image sequence corresponding to each of the target microholes; determining a plurality of in-plane velocity fields corresponding to each of the target microholes based on a preset digital speckle correlation algorithm and the plurality of microhole acid-etching images corresponding to each of the target microholes; determining a maximum velocity value in the plurality of in-plane velocity fields as a target velocity value corresponding to the sample microchannel plate blank; and determining the acid-etching speed of core glass corresponding to the sample microchannel plate blank.

### TECHNICAL FIELD

The present application relates to the technical field of microchannel plate performance detection, and particularly to a method and apparatus for detecting the acid-etching speed of core glass.

### BACKGROUND

A microchannel plate is an electron multiplication device composed of tens of millions of microchannels with inner diameters of 5-7 micrometers. It offers advantages such as small size, light mass, high resolution, high gain, low noise, and low operating voltage. When an electron enters a microchannel within the microchannel plate, it collides with the inner wall of the microhole and multiplies into hundreds of thousands of electrons, which are emitted from the opposite end of the microhole. This characteristic makes the microchannel plate a core component for photoelectric multiplication in devices such as low-light-level night vision devices and medical imaging instruments.

The preparation process of a microchannel plate is relatively complex: First, a clad glass tube and a core glass rod made of two different glass materials are nested together and drawn into micron-level filaments. Second, a large number of micron-level filaments are provided in an array and then hot-pressed to synthesize a rod bundle composed of a plurality of filaments. Third, the rod bundle is cut into slices with a thickness of approximately 0.8 mm to obtain a microchannel plate blank. Then, the microchannel plate blank is immersed in an acid solution. Due to the fact that the core glass is extremely susceptible to corrosion by the acid solution, while the clad glass has strong resistance to the acid solution, the acid solution is able to corrode away the core glass in the microchannel plate blank, while the clad glass is retained, thereby forming a large number of microholes. Finally, the corroded microchannel plate blank is subjected to hydrogen reduction, cold and hot processing and other operations to prepare the finished product of microchannel plate.

The electron-multiplying function of a microchannel plate resides in the clad glass of each microhole. Therefore, to achieve the best electron-multiplying effect, the core glass must be completely etched away during fabrication, while the clad glass must be fully preserved. However, although the clad glass exhibits strong resistance to the acid solution, prolonged immersion of the microchannel plate blank in the acid solution will still erode part of the clad glass. Therefore, when producing the finished product of microchannel plate from a plurality of microchannel plate blanks, it is necessary to first select sample microchannel plate blanks from the plurality of microchannel plate blanks and measure the acid-etching speed of the sample microchannel plate blanks (i.e., the corrosion speed of the core glass by the acid solution). In the subsequent fabrication process of the finished products of microchannel plate, the immersion time of each microchannel plate blank in the acid solution is determined based on the acid-etching speed corresponding to the sample microchannel plate blanks.

At present, the weighing method is commonly configured to detect the acid-etching speed of sample microchannel plate blanks. Specifically, the mass of a sample microchannel plate blank is first measured with an electronic balance. The sample microchannel plate blank is then immersed in an acid solution for a preset duration, after the sample microchannel plate blank is removed, the sample microchannel plate blank is reweighed with the electronic balance. Finally, the acid-etching speed of the sample microchannel plate blank is calculated based on the two measured masses, the preset duration, and the end-face region of the sample microchannel plate blank. However, when the electronic balance has low measurement accuracy or the detection staff lacks work experience and operates improperly, the mass of the sample microchannel plate blank is not able to be accurately measured, which may lead to inaccurate detection of the acid-etching speed of the sample microchannel plate blank.

### SUMMARY OF THE INVENTION

Embodiments of the present application provide a method and apparatus for detecting the acid-etching speed of core glass, primarily aimed at improving the accuracy of detecting the acid-etching speed of sample microchannel plate blanks.

To solve the above technical problem, embodiments of the present application provide the following technical solutions:

In a first aspect, the present application provides a method for detecting an acid-etching speed of core glass, the method including:
Obtaining an initial end-face image and an acid-etched end-face image sequence corresponding to a sample microchannel plate blank, wherein the initial end-face image is an image obtained by photographing a target region of the sample microchannel plate blank with a photographing device before acid-etching the target region with an acid solution, the acid-etched end-face image sequence includes a plurality of acid-etched end-face images, and the plurality of acid-etched end-face images are a plurality of consecutively photographed images obtained by photographing the target region with the photographing device after acid-etching the target region with the acid solution;
Selecting a plurality of target microholes in the initial end face image, and intercepting a microhole acid-etching image sequence corresponding to each of the target microholes from the plurality of acid-acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes includes a plurality of microhole acid-etching images corresponding to the target microholes;
Determining a plurality of in-plane velocity fields corresponding to each of the target microholes based on a preset digital speckle correlation algorithm and the plurality of microhole acid-etching images corresponding to each of the target microholes;
Determining a maximum velocity value in the plurality of in-plane velocity fields as a target velocity value corresponding to the sample microchannel plate blank; and
Determining the acid-etching speed of core glass corresponding to the sample microchannel plate blank according to the target velocity value and a preset data table, wherein the preset data table includes a plurality of preset motion velocity intervals and the acid-etching speed of core glass corresponding to each of the preset motion velocity intervals.

In a second aspect, the present application further provides an apparatus for detecting an acid-etching speed of core glass, the apparatus including:
An acquisition unit, configured to obtain an initial end face image and an acid-acid-etched end face image sequence corresponding to a sample microchannel plate blank, wherein the initial end face image is an image obtained by photographing a target region through a photographing device after irradiating the sample microchannel plate blank with a target light source, and the acid-acid-etched end face image sequence includes a plurality of acid-acid-etched end face images, and the plurality of acid-acid-etched end face images are sequence of images obtained by photographing the target region through the photographing device after irradiating the sample microchannel plate blank with the target light source and acid-etching the target region with an acid solution;
An interception unit, configured to select a plurality of target microholes in the initial end face image, and intercepting a microhole acid-etching image sequence corresponding to each of the target microholes from the plurality of acid-acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes includes a plurality of microhole acid-etching images corresponding to the target microholes;
A first determination unit, configured to determine a plurality of in-plane velocity fields corresponding to each of the target microholes based on a preset digital speckle correlation algorithm and the plurality of microhole acid-etching images corresponding to each of the target microholes;
A second determination unit, configured to determine a maximum velocity value in the plurality of in-plane velocity fields as a target velocity value corresponding to the sample microchannel plate blank; and
A third determination unit, configured to determine the acid-etching speed of core glass corresponding to the sample microchannel plate blank according to the target velocity value and a preset data table, wherein the preset data table includes a plurality of preset motion velocity intervals and the acid-etching speed of core glass corresponding to each of the preset motion velocity intervals.

In a third aspect, an embodiment of the present application provides a storage medium, the storage medium including a stored program, wherein when the program runs, the program controls the apparatus on which the storage medium is located to execute the method for detecting the acid-etching speed of core glass according to the first aspect.

In a fourth aspect, an embodiment of the present application provides a device for detecting the acid-etching speed of core glass, the device including a storage medium; and one or more processors, wherein the storage medium is coupled to the processors, and the processors are configured to execute program instructions stored in the storage medium; when the program instructions run, the method for detecting the acid-etching speed of core glass according to the first aspect is executed.

By means of the above technical solutions, the technical solutions provided by the present application have at least the following advantages:
The present application provides a method and apparatus for detecting the acid-etching speed of core glass. The method enables that, after the detection staff captures an initial end face image and a plurality of acid-etching end face images corresponding to a sample microchannel plate blank through a photographing device, and stores the initial end face image and the plurality of acid-etching end face images corresponding to the sample microchannel plate blank in the local storage space of a target terminal device, an acid-etching speed detection application program acquires the initial end face image and the plurality of acid-etching end face images corresponding to the sample microchannel plate blank from the local storage space of the target terminal device. Next, the acid-etching speed detection application program selects a plurality of target microholes in the initial end face image, and based on the position coordinates corresponding to each of the target microhole, extracts a microhole acid-etching image sequence corresponding to each of the target microholes from the plurality of acid-etched end face images. Then, based on a preset digital speckle correlation algorithm and the plurality of microhole acid-etching images contained in the microhole acid-etching image sequence corresponding to each of the target microholes, the application determines a plurality of in-plane velocity fields corresponding to each of the target microholes. Subsequently, the maximum velocity value among the plurality of in-plane velocity fields is determined as the target velocity value corresponding to the sample microchannel plate blank. Finally, the acid-etching speed of core glass corresponding to the sample microchannel plate blank is determined according to the target velocity value and a preset data table. Because in the present application, the detection staff only need to capture the initial end face image and the plurality of acid-etched end face images of the sample microchannel plate blank using a photographing device. The acid-etching speed detection application program may determine the acid-etching speed of core glass of the sample microchannel plate blank without any further intervention from the detection staff. Additionally, since an electronic balance is not configured in the process, the accuracy of detecting the acid-etching speed of the sample microchannel plate blank is ensured.

The above description merely outlines the technical solutions of the present application. To understand the technical means of the present application more clearly and implement them in accordance with the content of the specification, and to make the above and other objects, features, and advantages of the present application more apparent and understandable, specific embodiments of the present application are specifically set forth below.

### BRIEF DESCRIPTION OF THE DRAWINGS

By referring to the following detailed description of the exemplary embodiments of the present application in conjunction with the accompanying drawings, the above and other objects, features, and advantages of the present application will become readily understandable. In the drawings, several embodiments of the present application are shown in an exemplary and non-limiting manner, and like or corresponding reference numerals designate like or corresponding parts, wherein:

FIG. 1 shows a flow chart of a method for detecting an acid-etching speed of core glass provided by an embodiment of the present application;

FIG. 2 shows a flow chart of another method for detecting an acid-etching speed of core glass provided by an embodiment of the present application;

FIG. 3 shows a block diagram of a composition of an apparatus for detecting an acid-etching speed of core glass provided by an embodiment of the present application; and

FIG. 4 shows a block diagram of a composition of another apparatus for detecting an acid-etching speed of core glass provided by an embodiment of the present application.

### DETAILED DESCRIPTION OF SPECIFIC EMBODIMENTS

The exemplary embodiments of the present application will now be described in more details with reference to the accompanying drawings. While the drawings illustrate exemplary embodiments of the present application, it should be understood that the present application may be implemented in various forms and should not be limited by the embodiments set forth herein. Rather, these embodiments are provided to enable a more thorough understanding of the present application and to fully convey the scope of the present application to those skilled in the art.

Furthermore, the terms “first”, “second”, and similar terms configured in the present application do not denote any order, quantity, or importance, but are merely configured to distinguish different components.

It should be noted that unless otherwise specified, technical terms or scientific terms configured in the present application shall have the ordinary meaning as understood by those skilled in the art to which the present application pertains.

At present, the weighing method is commonly configured to detect the acid-etching speed of sample microchannel plate blanks. Specifically, the mass of a sample microchannel plate blank is first measured with an electronic balance. The sample microchannel plate blank is then immersed in an acid solution for a preset duration, after the sample microchannel plate blank is removed, the sample microchannel plate blank is reweighed with the electronic balance. Finally, the acid-etching speed of the sample microchannel plate blank is calculated based on the two measured masses, the preset duration, and the end-face region of the sample microchannel plate blank. However, when the electronic balance has low measurement accuracy or the detection staff lacks work experience and operates improperly, the mass of the sample microchannel plate blank is not able to be accurately measured, which may lead to inaccurate detection of the acid-etching speed of the sample microchannel plate blank.

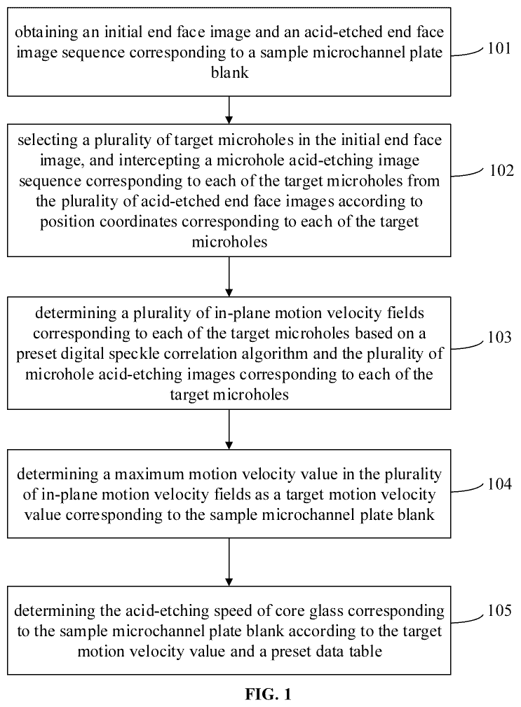

Therefore, in order to improve the accuracy of detecting the acid-etching speed of a sample microchannel plate blank, an embodiment of the present application provides a method for detecting an acid-etching speed of core glass. As shown in FIG. 1, the method at least includes steps 101 to 105.

101. Obtaining an initial end face image and an acid-etched end face image sequence corresponding to a sample microchannel plate blank.

Wherein the initial end face image is an image obtained by photographing a target region through a photographing device after irradiating the sample microchannel plate blank with a target light source, and the acid-etched end face image sequence includes a plurality of acid-etched end face images, and the plurality of acid-etched end face images are a plurality of sequence of images obtained by photographing the target region through the photographing device after irradiating the sample microchannel plate blank with the target light source and acid-etching the target region with an acid solution.

In the embodiments of the present application, the entity performing each of the steps is an acid-etching speed detection application executing on a target terminal device, wherein the target terminal device may include, but is not limited to, a computer, a tablet computer, a laptop computer, and the like.

Specifically, after the sample microchannel plate blank is placed on a specimen stage and irradiated with a target light source, the detection staff capture an image of a target region of the sample microchannel plate blank using a photographing device to obtain an initial end face image corresponding to the sample microchannel plate blank. The target light source is a light spot generated by expanding a laser beam emitted from a target laser using a beam expander. The target laser may include, but is not limited to, a 589.3 nm laser, a 632.8 nm laser, etc. Continuing to irradiate the sample microchannel plate blank with the target light source, after acid-etching the target region with an acid solution (i.e., dropping the acid solution onto the target region) and waiting for 10 seconds, the photographing device continuously captures images of the target region at a time interval of 1 second to obtain a plurality of acid-etched end face images corresponding to the sample microchannel plate blank. The acid solution configured may include, but is not limited to, nitric acid with a concentration of 65%. The photographing device is electrically connected to the target terminal device. After capturing the initial end face image and the plurality of acid-etched end face images corresponding to the sample microchannel plate blank, the photographing device transmits these images to the target terminal device, which stores the initial end face image and the plurality of acid-etched end face images (i.e., the acid-etched end face image sequence) in its local storage space. When it is necessary to detect the acid-etching speed of the sample microchannel plate blank, the acid-etching speed detection application program may retrieve the initial end face image and the plurality of acid-etched end face images corresponding to the sample microchannel plate blank from the local storage space of the target terminal device.

It should be noted that the digital speckle correlation algorithm is suitable for detecting pixel-level motion. The detection effect is better when the motion distance of the same pixel point between two images is approximately three pixels. When the photographing time interval is 1 second, the motion distance of the same pixel point between two adjacent acid-etched end face images is approximately three pixels, thereby ensuring a better detection effect.

It should be noted that the photographing device includes an industrial camera and a microscope. The magnification of the microscope may include, but is not limited to, 20×, 30×, 40×, or 50×. The camera chip size and pixel pitch of the industrial camera are determined based on the inner diameter of the microholes corresponding to the sample microchannel plate blank, the magnification of the microscope, and a preset rule. For example, the preset rule is as follows: (1) The inner diameter of each microhole contained in the sample microchannel plate blank should occupy at least 30 pixels in the end face image; (2) The larger the field of view of the photographing device, the better; (3) The budget cost of the photographing device is A. When the magnification of the microscope is 20× and the inner diameter of the microholes corresponding to the sample microchannel plate blank is 6 microns, the size (side length) of each pixel in the end face image should be less than 0.2 microns (6 microns divided by 30). Since the size (side length) of each pixel in the end face image is equal to the pixel pitch of the industrial camera divided by the magnification, the pixel pitch of the industrial camera needs to be less than 4 microns. The field of view of the photographing device is equal to the camera chip size of the industrial camera divided by the magnification of the microscope. With a fixed magnification of the microscope, the larger the camera chip size of the industrial camera, the larger the field of view of the photographing device. However, a larger camera chip size of the industrial camera results in a higher cost. Therefore, a camera chip with a larger size should be selected while ensuring that the budget cost of the photographing device is less than or equal to A.

102. Selecting a plurality of target microholes in the initial end face image, and intercepting a microhole acid-etching image sequence corresponding to each of the target microholes from the plurality of acid-etched end face images according to position coordinates corresponding to each of the target microholes.

For any target microhole, the position coordinates corresponding to the target microhole are configured to indicate the position of the target microhole in the initial end face image. Specifically, the position coordinates corresponding to the target microhole may be the position coordinates of the center of the target microhole in the initial end face image. The microhole acid-etching image sequence corresponding to the target microhole includes a plurality of microhole acid-etching images corresponding to the target microhole.

Since the positions of certain microholes in the acid-etched end face images are not easily determined, and for the same microhole, its position in the initial end face image and each acid-etched end face image remains fixed. Therefore, after the acid-etching speed detection application program acquires the initial end face image and the acid-etched end face image sequence corresponding to the sample microchannel plate blank, it may select a plurality of target microholes in the initial end face image, determine the position coordinates of each of the target microholes in the initial end face image, then find the position of each of the target microholes in each acid-etched end face image based on the position coordinates of each target microhole in the initial end face image, and extract the microhole acid-etching image corresponding to each of the target microholes from each acid-etched end face image to obtain a plurality of microhole acid-etching images corresponding to each of the target microholes, thereby forming the microhole acid-etching image sequence corresponding to each of the target microholes.

For any target microhole, after locating the position of the target microhole in a certain acid-etched end face image based on its position coordinates in the initial end face image, the microhole acid-etching image corresponding to the target microhole is extracted with the circle center of the target microhole as the center. That is, the center of the extracted microhole acid-etching image is the circle center of the target microhole.

For any target microhole, the extracted microhole acid-etching image corresponding to the target microhole is a square, and the side length of the microhole acid-etching image is twice the inner diameter of the target microhole.

103. Determining a plurality of in-plane velocity fields corresponding to each of the target microholes based on a preset digital speckle correlation algorithm and the plurality of microhole acid-etching images corresponding to each of the target microholes.

After extracting the microhole acid-etching image sequence corresponding to each of the target microholes, the acid-etching speed detection application program may determine the plurality of in-plane velocity fields corresponding to each of the target microholes based on the preset digital speckle correlation algorithm and the plurality of microhole acid-etching images corresponding to each of the target microholes.

104. Determining a maximum velocity value in the plurality of in-plane velocity fields as a target velocity value corresponding to the sample microchannel plate blank.

After determining the plurality of in-plane velocity fields corresponding to each of the target microholes, the acid-etching speed detection application program determines the maximum velocity value among the plurality of in-plane velocity fields as the target velocity value corresponding to the sample microchannel plate blank.

105. Determining the acid-etching speed of core glass corresponding to the sample microchannel plate blank according to the target velocity value and a preset data table.

Wherein the preset data table includes a plurality of preset motion velocity intervals and the acid-etching speed of core glass corresponding to each preset motion velocity interval. Specifically, an experienced detection staff will pre-detect the acid-etching speed of core glass of different batches of sample microchannel plate blanks using a high-precision electronic balance to obtain the acid-etching speed of core glass corresponding to each batch of sample microchannel plate blanks. He will also detect the target velocity values corresponding to different batches of sample microchannel plate blanks using the method described in the above steps 101-104. Subsequently, they will count the different target velocity values corresponding to the same acid-etching speed of core glass and determine the motion velocity interval corresponding to each acid-etching speed of core glass based on the different target velocity values corresponding to each acid-etching speed of core glass. In this way, a plurality of preset motion velocity intervals and the acid-etching speed of core glass corresponding to each preset motion velocity interval are obtained, that is, the preset data table.

After determining the target velocity value corresponding to the sample microchannel plate blank, the acid-etching speed detection application program may determine the acid-etching speed of core glass corresponding to the sample microchannel plate blank based on the target velocity value corresponding to the sample microchannel plate blank and the preset data table.

The present application provides a method for detecting the acid-etching speed of core glass. The embodiments of the present application enable that, after the detection staff captures an initial end face image and a plurality of acid-etching end face images corresponding to a sample microchannel plate blank through a photographing device, and stores the initial end face image and the plurality of acid-etching end face images corresponding to the sample microchannel plate blank in the local storage space of a target terminal device, an acid-etching speed detection application program acquires the initial end face image and the plurality of acid-etching end face images corresponding to the sample microchannel plate blank from the local storage space of the target terminal device. Next, the acid-etching speed detection application program selects a plurality of target microholes in the initial end face image, and based on the position coordinates corresponding to each of the target microhole, extracts a microhole acid-etching image sequence corresponding to each of the target microholes from the plurality of acid-etched end face images. Then, based on a preset digital speckle correlation algorithm and the plurality of microhole acid-etching images contained in the microhole acid-etching image sequence corresponding to each of the target microholes, the application determines a plurality of in-plane velocity fields corresponding to each of the target microholes. Subsequently, the maximum velocity value among the plurality of in-plane velocity fields is determined as the target velocity value corresponding to the sample microchannel plate blank. Finally, the acid-etching speed of core glass corresponding to the sample microchannel plate blank is determined according to the target velocity value and a preset data table. Because in the present application, the detection staff only need to capture the initial end face image and the plurality of acid-etched end face images of the sample microchannel plate blank using a photographing device. The acid-etching speed detection application program may determine the acid-etching speed of core glass of the sample microchannel plate blank without any further intervention from the detection staff. Additionally, since an electronic balance is not configured in the process, the accuracy of detecting the acid-etching speed of the sample microchannel plate blank is ensured.

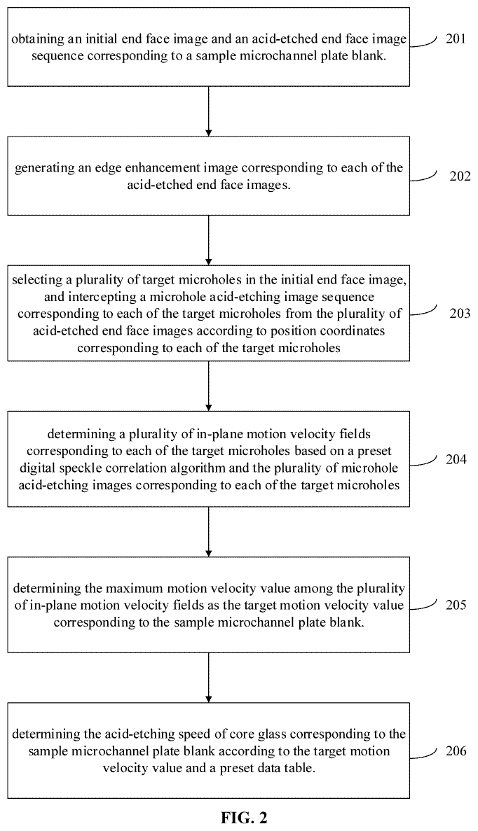

To provide a more detailed description, another method for detecting the acid-etching speed of core glass is provided in the embodiments of the present application, as specifically shown in FIG. 2. The method at least includes steps 201 to 206.

201. Obtaining an initial end face image and an acid-etched end face image sequence corresponding to a sample microchannel plate blank.

Wherein, for step 201 of obtaining the initial end face image and the acid-etched end face image sequence corresponding to the sample microchannel plate blank, reference may be made to the description of the corresponding part in FIG. 1, which will not be repeated here in the embodiments of the present application.

202. Generating an edge enhancement image corresponding to each of the acid-etched end face images.

After obtaining the initial end face image and the acid-etched end face image sequence corresponding to the sample microchannel plate blank, the acid-etching speed detection application program needs to perform speckle enhancement processing and edge enhancement processing on each of the acid-etched end face images to generate the edge enhancement image corresponding to each of the acid-etched end face image. The specific process is as follows:

(1) Generating a target speckle enhancement matrix and a target edge enhancement matrix corresponding to the plurality of acid-etched end face images.

First, calculate the number of pixels occupied by the inner diameters of the microholes based on the inner diameters of the microholes corresponding to the sample microchannel plate blank and the pixel pitchs (i.e., the side length of the pixel) of the acid-etched end face images. Specifically, divide the inner diameters of the microholes corresponding to the sample microchannel plate blank by the pixel pitchs of the acid-etched end face images, and determine the result of this calculation as the number of pixels occupied by the inner diameters of the microholes. Here, the number of pixels occupied by the inner diameters of the microholes refers to the number of pixels occupied by the inner diameters of the microholes in the acid-etched end face images.

Second, generating a target speckle enhancement matrix according to the number of pixels occupied by the inner diameters of the microholes.

Wherein, when the number of pixels occupied by the inner diameters of the microholes is an odd number, the generated target speckle enhancement matrix is specifically:

$$\begin{matrix}nk & nk & nk & … & nk & nk & nk \\ & nk & & ⋮ & & nk & \\ nk & & 1 / 8 & 1 / 8 & 1 / 8 & & nk \\ ⋮ & … & 1 / 8 & 1 & 1 / 8 & … & ⋮ \\ nk & & 1 / 8 & 1 / 8 & 1 / 8 & & nk \\ & nk & & ⋮ & & nk & \\ nk & nk & nk & … & nk & nk & nk\end{matrix}$$

Wherein, the target speckle enhancement matrix is a k*k matrix, the central element of the target speckle enhancement matrix is 1, the elements surrounding the central element in a circle are 1/8, and the remaining elements in the target speckle enhancement matrix are nk; wherein, the sum of the plurality of elements contained in the target speckle enhancement matrix is equal to 1.

Wherein,

$$nk = \frac{1}{( k + 3 ) ( k - 3 )} ,$$

and k is the number of pixels occupied by the inner diameters of the microholes.

Wherein, when the number of pixels occupied by the inner diameters of the microholes is an even number, the generated target speckle enhancement matrix is specifically:

$$\begin{matrix}nk & nk & nk & … & nk & nk & nk \\ & nk & & ⋮ & & nk & \\ nk & nk & nk & & nk & nk & nk \\ ⋮… & nk & 1 / 2 & & 1 / 2 & nk & …⋮ \\ ⋮… & nk & 1 / 2 & & 1 / 2 & nk & …⋮ \\ nk & nk & nk & & nk & nk & nk \\ & nk & & ⋮ & & nk & \\ nk & nk & nk & … & nk & nk & nk\end{matrix}$$

Wherein, the target speckle enhancement matrix is a k*k matrix centered around a 2*2 matrix where each element of the 2*2 matrix is 1/2, and the remaining elements in the target speckle enhancement matrix are nk; wherein, the sum of the plurality of elements contained in the target speckle enhancement matrix is equal to 1.

Wherein,

$$n k = - \frac{1}{( k - 2 ) ( k + 2 )} ,$$

and k is the number of pixels occupied by the inner diameters of the microholes.

Finally, generate a target edge enhancement matrix according to the number of pixels occupied by the inner diameters of the microholes.

Wherein, when the number of pixels occupied by the inner diameters of the microholes is an odd number, the generated target edge enhancement matrix is specifically:

$$\begin{matrix}n 2 & n 2 & n 2 & … & n 2 & n 2 & n 2 \\ & n 2 & & ⋮ & & n 2 & \\ n 2 & & n 1 & n 1 & n 1 & & n 2 \\ ⋮ & … & n 1 & 1 & n 1 & … & ⋮ \\ n 2 & & n 1 & n 1 & n 1 & & n 2 \\ & n 2 & & ⋮ & & n 2 & \\ n 2 & n 2 & n 2 & … & n 2 & n 2 & n 2\end{matrix}$$

Wherein, the target edge enhancement matrix is a k*k matrix, the central element of the target edge enhancement matrix is 1, the outermost circle of elements is n2, and the remaining elements in the target edge enhancement matrix are n1; wherein, the sum of the plurality of elements contained in the target edge enhancement matrix is equal to 1.

Wherein,

$$n 1 = - \frac{1}{{k}^{2} - 4 k + 3} , n 2 = \frac{1}{4 k - 4} ,$$

and k is the number of pixels occupied by the inner diameters of the microholes.

Wherein, when the number of pixels occupied by the inner diameters of the microholes is an even number, the generated target edge enhancement matrix is specifically:

$$n 1 = - \frac{1}{{k}^{2} - 4 k + 3} , n 2 = \frac{1}{4 k - 4} ,$$

Wherein, the target edge enhancement matrix is a k*k matrix centered around a 2*2 matrix where each element of the 2*2 matrix is 1/4, the outermost circle of elements is n4, and the remaining elements in the target edge enhancement matrix are n3; wherein, the sum of the plurality of elements contained in the target edge enhancement matrix is equal to 1.

Wherein,

$$n 3 = - \frac{1}{{k}^{2} - 4 k} , n 4 = \frac{1}{4 k - 4} ,$$

and k is the number of pixels occupied by the inner diameters of the microholes.

(2) Perform convolution processing on each of the acid-etched end face images using the target speckle enhancement matrix to obtain a speckle enhancement image corresponding to each of the acid-etched end face images.

Wherein, the type of convolution operation performed may specifically be a same convolution operation. That is, for any acid-etched end face image, the target speckle enhancement matrix is configured to perform a same convolution operation on the acid-etched end face images to obtain speckle enhancement images corresponding to the acid-etched end face images.

Wherein, performing convolution processing on the acid-etched end face images with the target speckle enhancement matrix may enhance the speckle features in the acid-etched end face images.

(3) Performing convolution calculation processing on each of the speckle enhancement images using the target edge enhancement matrix to obtain an edge enhancement image corresponding to each of the acid-etched end face images.

Wherein, the type of convolution operation performed may specifically be a same convolution operation. That is, for any speckle enhancement image, the target edge enhancement matrix is configured to perform a same convolution operation on the speckle enhancement image to obtain an edge enhancement matrix corresponding to the speckle enhancement image.

Wherein, performing convolution processing on the speckle enhancement images with the target edge enhancement matrix may effectively control the blurring phenomenon of the microhole boundaries configured by acid etching.

203. Selecting a plurality of target microholes in the initial end face image, and intercepting a microhole acid-etching image sequence corresponding to each of the target microholes from the plurality of acid-etched end face images according to position coordinates corresponding to each of the target microholes.

Wherein, regarding 203. Selecting the plurality of target microholes in the initial end face image, and intercepting a microhole acid-etching image sequence corresponding to each of the target microholes from the plurality of acid-etched end face images according to position coordinates corresponding to each of the target microholes, reference may be made to the relevant description in step 102 above, which will not be repeated here in this embodiment of the present application.

It should be noted that, for any target microhole, the intercepted microhole acid etching image corresponding to the target microhole is a square, and the side length of the microhole acid-etching image is twice the inner diameter of the target microhole. That is, when the number of pixels occupied by the inner diameters of the microholes is k, the size of the intercepted microhole acid-etching image is 2k*2k.

204. Determining a plurality of in-plane velocity fields corresponding to each of the target microholes based on a preset digital speckle correlation algorithm and the plurality of microhole acid-etching images corresponding to each of the target microholes.

After intercepting the microhole acid-etching image sequence corresponding to each of the target microholes, the acid-etching speed detection application program may determine a plurality of in-plane velocity fields corresponding to each of the target microholes based on the preset digital speckle correlation algorithm and the plurality of microhole acid-etching images corresponding to each of the target microholes. The following will provide a detailed explanation of how the acid-etching speed detection application program determines the plurality of in-plane velocity fields corresponding to each of the target microholes based on the preset digital speckle correlation algorithm and the plurality of microhole acid-etching images corresponding to each of the target microholes.

For any target microhole, first, grouping the plurality of microhole acid-etching images according to the shooting sequence of each of the microhole acid-etching image corresponding to the target microhole, to obtain a plurality of image groups. Wherein, for any microhole acid-etching image, the shooting sequence corresponding to the microhole acid-etching image is the shooting sequence corresponding to the acid-etched end face image to which the microhole acid-etching image belongs, and each of the image groups includes two microhole acid-etching images with adjacent shooting sequences. Next, extracting the in-plane velocity field corresponding to each of the image groups based on the preset digital speckle correlation algorithm. Finally, determining the plurality of in-plane velocity fields corresponding to the target microhole according to the plurality of in-plane velocity fields and the shooting time interval between two adjacent microhole acid-etching images. Specifically, for any in-plane velocity field, divide each in-plane velocity value contained in the in-plane velocity field by the shooting time interval to obtain a velocity value corresponding to each in-plane velocity value, and then derive the in-plane velocity field corresponding to the in-plane velocity field based on the plurality of velocity values.

Wherein, the specific process of extracting the in-plane velocity field corresponding to each of the image groups based on the preset digital speckle correlation algorithm is:

Wherein, the size of the preset window is determined according to the number of pixels occupied by the inner diameters of the microholes, that is, when the number of pixels occupied by the inner diameters of the microholes is k, the size of the preset window is k*k.

For any image group, first, perform segmentation on the first microhole acid-etching image contained in the image group using a preset window to obtain a plurality of first subregions, and perform segmentation on the second microhole acid-etching image contained in the image group using the preset window to obtain a plurality of second subregions. That is, take the pixel with position coordinates (k/2, k/2) in the first microhole acid-etching image as the center, and segment the first microhole acid-etching image with the preset window to obtain a first subregion composed of k*k pixels, where the center pixel of the first subregion has position coordinates (k/2, k/2). Take the pixel with position coordinates (k/2, k/2+1) in the first microhole acid-etching image as the center, and segment the first microhole acid-etching image with the preset window to obtain a second subregion composed of k*k pixels, where the center pixel of the first subregion has position coordinates (k/2, k/2+1) . . . . Take the pixel with position coordinates (k/2+1, k/2) in the first microhole acid-etching image as the center, and segment the first microhole acid-etching image with the preset window to obtain a (k+1)th subregion composed of k*k pixels, where the center pixel of the first subregion has position coordinates (k/2+1, k/2) . . . , similarly, segment the second microhole acid-etching image with the preset window to obtain a plurality of second subregions, wherein the shooting sequence of the acid-etched end face image to which the first microhole acid-etching image belongs is prior to that of the acid-etched end face image to which the second microhole acid-etching image belongs. Secondly, determining the target second subregion corresponding to each of the first subregions; furthermore, determining the in-plane velocity value corresponding to the central pixel of each of the first subregions based on the position coordinates of the central pixel of each of the first subregions and the position coordinates of the central pixel of the target second subregion corresponding to the first subregion. That is, for any first subregion, calculating the distance from the central pixel of the first subregion to the central pixel of the target second subregion corresponding to the first subregion based on their position coordinates, and determining the calculated distance as the in-plane velocity value of the central pixel of the first subregion. Finally, generating the in-plane velocity field corresponding to the image group based on the in-plane velocity values of the central pixels of the plurality of first subregions.

Wherein, the specific process for determining the target second subregion corresponding to each of the first subregions is as follows: For any first subregion, first, calculating the correlation coefficient between the first subregion and each of the second subregions based on the grayscale value of each pixel contained in the first subregion and the grayscale value of each pixel contained in each of the second subregions. Second, determining the second subregion corresponding to the maximum correlation coefficient among the plurality of correlation coefficients as the target second subregion corresponding to the first subregion.

Wherein, the correlation coefficient between the first subregion and each of the second subregions may be calculated based on a correlation coefficient calculation formula, but is not limited thereto.

205. Determining the maximum velocity value among the plurality of in-plane velocity fields as the target velocity value corresponding to the sample microchannel plate blank.

Wherein, regarding step 205 of determining the maximum velocity value among the plurality of in-plane velocity fields as the target velocity value corresponding to the sample microchannel plate blank, reference may be made to the description of the corresponding part in FIG. 1, which will not be repeated here in this embodiment of the present application.

206. Determining the acid-etching speed of core glass corresponding to the sample microchannel plate blank according to the target velocity value and a preset data table.

After the acid-etching speed detection application program determines the target velocity value corresponding to the sample microchannel plate blank, it may determine the acid-etching speed of core glass corresponding to the sample microchannel plate blank based on the target velocity value and the preset data table.

Specifically, in this step, the specific process for the acid-etching speed detection application program to determine the acid-etching speed of core glass corresponding to the sample microchannel plate blank based on the target velocity value and the preset data table is as follows:

First, matching the target velocity value with a plurality of preset motion velocity intervals; second, determining the acid-etching speed of core glass corresponding to the successfully matched preset motion velocity interval as the acid-etching speed of core glass corresponding to the sample microchannel plate blank.

Further, as an implementation of the methods shown in FIGS. 1 and 2, another embodiment of the present application provides an apparatus for detecting the acid-etching speed of core glass. This apparatus embodiment corresponds to the aforementioned method embodiments. For ease of reading, details from the method embodiments will not be repeated here, but it should be clear that the apparatus in this embodiment may implement all the content of the aforementioned method embodiments. This apparatus is configured to improve the accuracy of detecting the acid-etching speed of a sample microchannel plate blank. As specifically shown in FIG. 3, the apparatus includes:

An acquisition unit 31, configured to obtain an initial end face image and an acid-etched end face image sequence corresponding to a sample microchannel plate blank, wherein the initial end face image is an image obtained by photographing a target region through a photographing device after irradiating the sample microchannel plate blank with a target light source, and the acid-etched end face image sequence includes a plurality of acid-etched end face images, and the plurality of acid-etched end face images are sequence of images obtained by photographing the target region through the photographing device after irradiating the sample microchannel plate blank with the target light source and acid-etching the target region with an acid solution.

An interception unit 32, configured to select a plurality of target microholes in the initial end face image, and intercepting a microhole acid-etching image sequence corresponding to each of the target microholes from the plurality of acid-acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes includes a plurality of microhole acid-etching images corresponding to the target microholes.

A first determination unit 33, configured to determine a plurality of in-plane velocity fields corresponding to each of the target microholes based on a preset digital speckle correlation algorithm and the plurality of microhole acid-etching images corresponding to each of the target microholes.

A second determination unit 34, configured to determine a maximum velocity value in the plurality of in-plane velocity fields as a target velocity value corresponding to the sample microchannel plate blank; and

A third determination unit 35, configured to determine the acid-etching speed of core glass corresponding to the sample microchannel plate blank according to the target velocity value and a preset data table, wherein the preset data table includes a plurality of preset motion velocity intervals and the acid-etching speed of core glass corresponding to each of the preset motion velocity intervals.

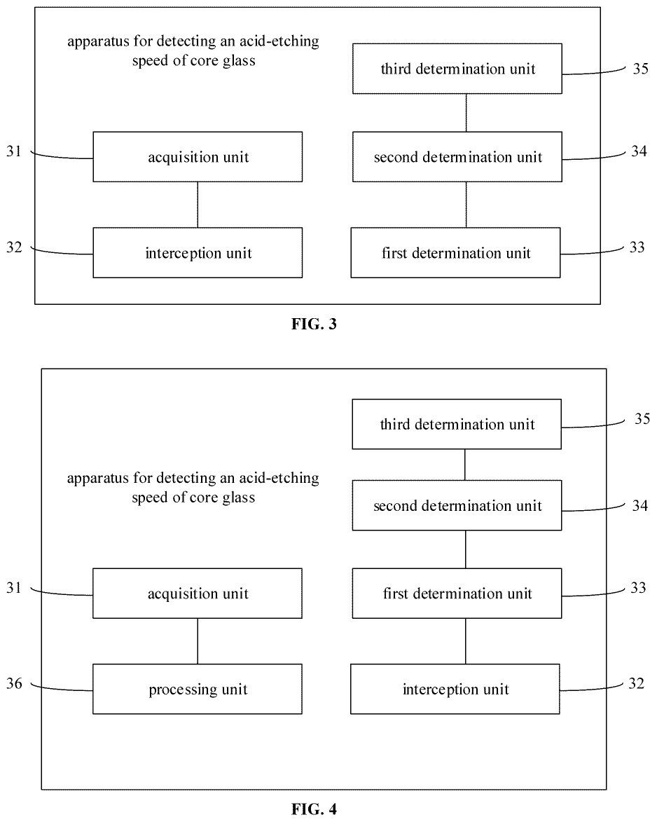

Further, as shown in FIG. 4, the apparatus further includes:

A processing unit 36, configured to generate a target speckle enhancement matrix and a target edge enhancement matrix corresponding to the plurality of acid-etched end face images after the acquisition unit 31 obtains the initial end face image and the acid-etched end face image sequence corresponding to the sample microchannel plate blank; perform convolution operation processing on each of the acid-etched end face images using the target speckle enhancement matrix to obtain a speckle enhancement image corresponding to each of the acid-etched end face images; and perform convolution operation processing on each of the speckle enhancement image using the target edge enhancement matrix to obtain an edge enhancement image corresponding to each of the acid-etched end face images.

The interception unit 32 is specifically configured to intercept a microhole acid-etching image sequence corresponding to each of the target microholes from the plurality of edge enhancement images according to the position coordinates corresponding to each of the target microholes.

Further, as shown in FIG. 4, the processing unit 36 is specifically configured to calculate the number of pixels occupied by the inner diameters of the microholes according to the inner diameters of the microholes corresponding to the sample microchannel plate blank and the pixel pitchs corresponding to the acid-etched end face images; generate the target speckle enhancement matrix according to the number of pixels occupied by the inner diameters of the microholes; and generate the target edge enhancement matrix according to the number of pixels occupied by the inner diameters of the microholes.

Further, as shown in FIG. 4, the first determining unit 33 is specifically configured to perform grouping processing on the plurality of microhole acid-etching images according to the shooting sequence of each microhole acid-etching image corresponding to the target microhole to obtain a plurality of image groups, where each of the image groups includes two microhole acid-etching images with adjacent shooting sequences; extract the in-plane velocity field corresponding to each of the image groups based on the preset digital speckle correlation algorithm; and determine a plurality of in-plane velocity fields corresponding to the target microholes according to the plurality of in-plane velocity fields and the shooting time interval between two adjacent microhole acid-etching images.

Further, as shown in FIG. 4, the first determining unit 33 is specifically configured to segment the first microhole acid-etching image contained in the image group using a preset window to obtain a plurality of first subregions, and segment the second microhole acid-etching image contained in the image group using the preset window to obtain a plurality of second subregions; determine the target second subregion corresponding to each of the first subregions; determine the in-plane velocity value corresponding to the central pixel of each of the first subregions based on the position coordinates of the central pixel of each of the first subregions and the position coordinates of the central pixel of the target second subregion corresponding to the first subregions; and generate the in-plane velocity field corresponding to the image group based on the in-plane velocity values corresponding to the central pixels of the plurality of first subregions.

Further, as shown in FIG. 4, the first determining unit 33 is specifically configured to calculate the correlation coefficient between the first subregions and each of the second subregions based on the grayscale value of each pixel contained in the first subregions and the grayscale value of each pixel contained in each of the second subregions; and determine the second subregion corresponding to the maximum correlation coefficient among the plurality of correlation coefficients as the target second subregion corresponding to the first subregion.

Further, as shown in FIG. 4, the third determining unit 35 is specifically configured to match the target velocity value with the plurality of preset motion velocity intervals; and determine the acid-etching speed of core glass corresponding to the successfully matched preset motion velocity interval as the acid-etching speed of core glass corresponding to the sample microchannel plate blank.

The present application provides a method and apparatus for detecting the acid-etching speed of core glass. The embodiments of the present application enable that, after the detection staff captures an initial end face image and a plurality of acid-etching end face images corresponding to a sample microchannel plate blank through a photographing device, and stores the initial end face image and the plurality of acid-etching end face images corresponding to the sample microchannel plate blank in the local storage space of a target terminal device, an acid-etching speed detection application program acquires the initial end face image and the plurality of acid-etching end face images corresponding to the sample microchannel plate blank from the local storage space of the target terminal device. Next, the acid-etching speed detection application program selects a plurality of target microholes in the initial end face image, and based on the position coordinates corresponding to each of the target microhole, extracts a microhole acid-etching image sequence corresponding to each of the target microholes from the plurality of acid-etched end face images. Then, based on a preset digital speckle correlation algorithm and the plurality of microhole acid-etching images contained in the microhole acid-etching image sequence corresponding to each of the target microholes, the application determines a plurality of in-plane velocity fields corresponding to each of the target microholes. Subsequently, the maximum velocity value among the plurality of in-plane velocity fields is determined as the target velocity value corresponding to the sample microchannel plate blank. Finally, the acid-etching speed of core glass corresponding to the sample microchannel plate blank is determined according to the target velocity value and a preset data table. Because in the present application, the detection staff only need to capture the initial end face image and the plurality of acid-etched end face images of the sample microchannel plate blank using a photographing device. The acid-etching speed detection application program may determine the acid-etching speed of core glass of the sample microchannel plate blank without any further intervention from the detection staff. Additionally, since an electronic balance is not configured in the process, the accuracy of detecting the acid-etching speed of the sample microchannel plate blank is ensured.

An embodiment of the present application provides a storage medium including a stored program, wherein when the program runs, the program controls the apparatus on which the storage medium is located to execute the method for detecting the acid-etching speed of core glass as described above.

The storage medium may include non-permanent memory in computer-readable medium, forms such as random-access memory (RAM) and/or non-volatile memory, such as read-only memory (ROM) or flash RAM. The memory includes at least one storage chip.

An embodiment of the present application further provides a device for detecting an acid-etching speed of core glass, the device includes a storage medium; and one or more processors, wherein the storage medium is coupled to the processors, and the processors are configured to execute program instructions stored in the storage medium; when the program instructions run, the method for detecting the acid-etching speed of core glass as described above is executed.

An embodiment of the present application provides a device. The device includes a processor, a memory, and a program stored in the memory and executable on the processor. When the processor executes the program, the following steps are implemented:
Obtaining an initial end-face image and an acid-etched end-face image sequence corresponding to a sample microchannel plate blank, wherein the initial end-face image is an image obtained by photographing a target region of the sample microchannel plate blank with a photographing device before acid-etching the target region with an acid solution, the acid-etched end-face image sequence includes a plurality of acid-etched end-face images, and the plurality of acid-etched end-face images are a plurality of consecutively photographed images obtained by photographing the target region with the photographing device after acid-etching the target region with the acid solution;
Selecting a plurality of target microholes in the initial end face image, and intercepting a microhole acid-etching image sequence corresponding to each of the target microholes from the plurality of acid-acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes includes a plurality of microhole acid-etching images corresponding to the target microholes;
Determining a plurality of in-plane velocity fields corresponding to each of the target microholes based on a preset digital speckle correlation algorithm and the plurality of microhole acid-etching images corresponding to each of the target microholes;
Determining a maximum velocity value in the plurality of in-plane velocity fields as a target velocity value corresponding to the sample microchannel plate blank; and
Determining the acid-etching speed of core glass corresponding to the sample microchannel plate blank according to the target velocity value and a preset data table, wherein the preset data table includes a plurality of preset motion velocity intervals and the acid-etching speed of core glass corresponding to each of the preset motion velocity intervals.

Further, after obtaining the initial end-face image and the acid-etched end-face image sequence corresponding to the sample microchannel plate blank, the method further includes:
Generating a target speckle enhancement matrix and a target edge enhancement matrix corresponding to the plurality of acid-etched end face images;
Performing convolution operation processing on each of the acid-etched end face images using the target speckle enhancement matrix to obtain a speckle enhancement image corresponding to each of the acid-etched end face images; and
Performing convolution operation processing on each of the speckle enhancement image using the target edge enhancement matrix to obtain an edge enhancement image corresponding to each of the acid-etched end face images.

Intercepting a microhole acid-etching image sequence corresponding to each of the target microholes from the plurality of acid-acid-etched end face images according to position coordinates corresponding to each of the target microholes, including:

Intercepting a microhole acid-etching image sequence corresponding to each of the target microholes from the plurality of edge enhancement images according to the position coordinates corresponding to each of the target microholes.

Further, generating a target speckle enhancement matrix and a target edge enhancement matrix corresponding to the plurality of acid-etched end face images, including:
Calculating the number of pixels occupied by the inner diameters of the microholes according to the inner diameters of the microholes corresponding to the sample microchannel plate blank and the pixel pitchs corresponding to the acid-etched end face images;
Generating the target speckle enhancement matrix according to the number of pixels occupied by the inner diameters of the microholes; and
Generating the target edge enhancement matrix according to the number of pixels occupied by the inner diameters of the microholes.

Further, determining a plurality of in-plane velocity fields corresponding to each of the target microholes based on a preset digital speckle correlation algorithm and the plurality of microhole acid-etching images corresponding to each of the target microholes, including:

Performing grouping processing on the plurality of microhole acid-etching images according to the shooting sequence of each microhole acid-etching image corresponding to the target microhole to obtain a plurality of image groups, where each of the image groups includes two microhole acid-etching images with adjacent shooting sequences.

Extracting the in-plane velocity field corresponding to each of the image groups based on the preset digital speckle correlation algorithm; and

Determine a plurality of in-plane velocity fields corresponding to the target microholes according to the plurality of in-plane velocity fields and the shooting time interval between two adjacent microhole acid-etching images.

Further, extracting the in-plane velocity field corresponding to each of the image groups based on the preset digital speckle correlation algorithm, including:
Segmenting the first microhole acid-etching image contained in the image group using a preset window to obtain a plurality of first subregions, and segment the second microhole acid-etching image contained in the image group using the preset window to obtain a plurality of second subregions; determine the target second subregion corresponding to each of the first subregions;
Determining the target second subregion corresponding to each of the first subregions;
Determining the in-plane velocity value corresponding to the central pixel of each of the first subregions based on the position coordinates of the central pixel of each of the first subregions and the position coordinates of the central pixel of the target second subregion corresponding to the first subregions; and
Generating the in-plane velocity field corresponding to the image group based on the in-plane velocity values corresponding to the central pixels of the plurality of first subregions.

Further, determine the target second subregion corresponding to each of the first subregions, including:
Calculating the correlation coefficient between the first subregions and each of the second subregions based on the grayscale value of each pixel contained in the first subregions and the grayscale value of each pixel contained in each of the second subregions; and
Determining the second subregion corresponding to the maximum correlation coefficient among the plurality of correlation coefficients as the target second subregion corresponding to the first subregion.

Further, determining the acid-etching speed of core glass corresponding to the sample microchannel plate blank according to the target velocity value and a preset data table, including:
Matching the target velocity value with the plurality of preset motion velocity intervals; and
Determining the acid-etching speed of core glass corresponding to the successfully matched preset motion velocity interval as the acid-etching speed of core glass corresponding to the sample microchannel plate blank.

The present application further provides a computer program product which, when executed on a data processing device, is adapted to execute program code initialized with the following method steps: Obtaining an initial end face image and an acid-etched end face image sequence corresponding to a sample microchannel plate blank, wherein the initial end face image is an image obtained by photographing a target region through a photographing device after irradiating the sample microchannel plate blank with a target light source, and the acid-etched end face image sequence includes a plurality of acid-etched end face images, and the plurality of acid-etched end face images are sequence of images obtained by photographing the target region through the photographing device after irradiating the sample microchannel plate blank with the target light source and acid-etching the target region with an acid solution; selecting a plurality of target microholes in the initial end face image, and intercepting a microhole acid-etching image sequence corresponding to each of the target microholes from the plurality of acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes includes a plurality of microhole acid-etching images corresponding to the target microholes; determining a plurality of in-plane velocity fields corresponding to each of the target microholes based on a preset digital speckle correlation algorithm and the plurality of microhole acid-etching images corresponding to each of the target microholes; Determining a maximum velocity value in the plurality of in-plane velocity fields as a target velocity value corresponding to the sample microchannel plate blank; and determining the acid-etching speed of core glass corresponding to the sample microchannel plate blank according to the target velocity value and a preset data table, wherein the preset data table includes a plurality of preset motion velocity intervals and the acid-etching speed of core glass corresponding to each of the preset motion velocity intervals.

Those skilled in the art should understand that the embodiments of the present application may be provided as a method, system, or computer program product. Therefore, the present application may take the form of a complete hardware embodiment, a complete software embodiment, or an embodiment combining software and hardware aspects. Furthermore, the present application may take the form of a computer program product implemented on one or more computer-usable storage medium (including but not limited to magnetic disk storage, CD-ROM, optical storage, etc.) that contain computer-usable program code.

The present application is described with reference to flowcharts and/or block diagrams of methods, devices (systems), and computer program products according to embodiments of the present application. It should be understood that each flow and/or block in the flowcharts and/or block diagrams, and combinations of flows and/or blocks in the flowcharts and/or block diagrams, may be implemented by computer program instructions. These computer program instructions may be provided to a processor of a general-purpose computer, special-purpose computer, embedded processor, or other programmable data processing device to produce a machine such that the instructions, which execute via the processor of the computer or other programmable data processing device, create means for implementing the functions specified in the flowchart one flow or multiple flows and/or the block diagram one block or multiple blocks.

These computer program instructions may also be stored in a computer-readable memory that may direct a computer or other programmable data processing device to function in a particular manner, such that the instructions stored in the computer-readable memory produce an article of manufacture including instruction means which implement the functions specified in one flow or multiple flows in the flowchart and/or one block or multiple blocks of the block diagram.

These computer program instructions may also be loaded onto a computer or other programmable data processing device, such that a series of operational steps are performed on the computer or other programmable device to produce a computer-implemented process, whereby the instructions which execute on the computer or other programmable device provide steps for implementing the functions specified in one flow or multiple flows in the flowchart and/or one block or multiple blocks of the block diagram.

In a typical configuration, a computing device includes one or more processors (CPUs), input/output interfaces, a network interface, and memory.

The memory may include non-permanent memory in the form of random access memory (RAM) and/or non-volatile memory, such as read-only memory (ROM) or flash RAM, within a computer-readable medium. The memory is an example of a computer-readable medium.

The computer-readable medium includes both permanent and non-permanent, removable and non-removable medium, and information storage may be implemented by any method or technology. The information may be computer-readable instructions, data structures, program modules, or other data. Examples of computer storage medium include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory, or other memory technologies, compact disc read-only memory (CD-ROM), digital versatile disc (DVD), or other optical storage, magnetic cassettes, magnetic tape disk storage, or other magnetic storage devices, or any other non-transitory medium that may be used to store information accessible by a computing device. As defined herein, computer-readable medium does not include transitory medium, such as modulated data signals and carrier waves.

It should also be noted that the term “comprise”, “include”, or any other variant thereof is intended to cover a non-exclusive inclusion, such that a process, method, article, or device including a series of elements not only includes those elements but also includes other elements not explicitly listed, or elements inherent to such process, method, article, or device. Without further limitation, an element defined by the phrase “including a . . . ” does not exclude the presence of additional identical elements in the process, method, article, or device comprising the element.

Those skilled in the art should understand that embodiments of the present application may be provided as a method, system, or computer program product. Accordingly, the present application may take the form of an entirely hardware embodiment, an entirely software embodiment, or an embodiment combining software and hardware aspects. Furthermore, the present application may take the form of a computer program product implemented on one or more computer-usable storage media (including but not limited to disk storage, CD-ROM, optical storage, etc.) having computer-usable program code embodied therein.

The above are only embodiments of the present application and are not intended to limit the present application. For those skilled in the art, the present application may have various modifications and changes. Any modifications, equivalent replacements, improvements, etc. made within the spirit and principles of the present application shall be included in the scope of the claims of the present application.

The listing of claims:

1. A method for detecting an acid-etching speed of core glass, comprising:
obtaining an initial end face image and an acid-etched end face image sequence corresponding to a sample microchannel plate blank, wherein the initial end face image is an image obtained by photographing a target region through a photographing device after irradiating the sample microchannel plate blank with a target light source, and the acid-etched end face image sequence comprises a plurality of acid-etched end face images, and the plurality of acid-etched end face images are sequence of images obtained by photographing the target region through the photographing device after irradiating the sample microchannel plate blank with the target light source and acid-etching the target region with an acid solution;
selecting a plurality of target microholes in the initial end face image, and intercepting a microhole acid-etching image sequence corresponding to each of the target microholes from the plurality of acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes comprises a plurality of microhole acid-etching images corresponding to the target microholes;
determining a plurality of in-plane velocity fields corresponding to each of the target microholes based on a preset digital speckle correlation algorithm and the plurality of microhole acid-etching images corresponding to each of the target microholes;
determining a maximum velocity value in the plurality of in-plane velocity fields as a target velocity value corresponding to the sample microchannel plate blank; and
determining the acid-etching speed of core glass corresponding to the sample microchannel plate blank according to the target velocity value and a preset data table, wherein the preset data table comprises a plurality of preset motion velocity intervals and the acid-etching speed of core glass corresponding to each of the preset motion velocity intervals.

2. The method according to claim 1, wherein after the obtaining the initial end face image and the acid-etched end face image sequence corresponding to the sample microchannel plate blank, the method further comprises:
generating a target speckle enhancement matrix and a target edge enhancement matrix corresponding to the plurality of acid-etched end face images;
performing convolution operation processing on each of the acid-etched end face images by using the target speckle enhancement matrix to obtain a speckle enhancement image corresponding to each of the acid-etched end face images;
performing convolution budget processing on each speckle enhancement image by using the target edge enhancement matrix to obtain an edge enhancement image corresponding to each of the acid-etched end face images; and
the intercepting the microhole acid-etching image sequence corresponding to each of the target microholes from the plurality of acid-etched end face images according to the position coordinates corresponding to each of the target microholes comprises:
intercepting the microhole acid-etching image sequence corresponding to each of the target microholes from the plurality of edge enhancement images according to the position coordinates corresponding to each of the target microholes.

3. The method according to claim 2, wherein the generating the target speckle enhancement matrix and the target edge enhancement matrix corresponding to the plurality of acid-etched end face images comprises:
calculating a number of pixel points occupied by inners diameter of microholes according to the inner diameters of the microholes corresponding to the sample microchannel plate blank and a pixel point size corresponding to the acid-etched end face image;
generating the target speckle enhancement matrix according to the number of pixel points occupied by the inner diameters of the microholes; and
generating the target edge enhancement matrix according to the number of pixel points occupied by the inner diameters of the microholes.

4. The method according to claim 1, wherein the determining the plurality of in-plane velocity fields corresponding to each of the target microholes based on the preset digital speckle correlation algorithm and the plurality of microhole acid-etching images corresponding to each of the target microholes comprises:
performing grouping processing on the plurality of microhole acid-etching images according to the photographing sequence of each of the microhole acid-etching images corresponding to the target microholes to obtain a plurality of image groups, wherein each of the image groups comprises two microhole acid-etching images with adjacent photographing sequences;
extracting an in-plane velocity field corresponding to each of the image groups based on the preset digital speckle correlation algorithm; and
determining the plurality of in-plane velocity fields corresponding to the target microholes according to the plurality of in-plane velocity fields and a photographing time interval corresponding to two adjacent microhole acid-etching images.

5. The method according to claim 4, wherein the extracting the in-plane velocity field corresponding to each of the image groups based on the preset digital speckle correlation algorithm comprises:
performing segmentation processing on a first microhole acid-etching image comprised in the image groups by using a preset window to obtain a plurality of first sub-regions, and performing segmentation processing on a second microhole acid-etching image comprised in the image groups by using the preset window to obtain a plurality of second sub-regions;
determining a target second sub-region corresponding to each of the first sub-regions;
determining an in-plane velocity value corresponding to a central pixel point of each of the first sub-regions according to the position coordinates of the central pixel point of each of the first sub-regions and the position coordinates of the central pixel point of the target second sub-region corresponding to each of first sub-regions; and
generating the in-plane velocity field corresponding to the image groups according to the in-plane velocity values corresponding to the central pixel points of the plurality of first sub-regions.

6. The method according to claim 5, wherein the determining the target second sub-region corresponding to each of the first sub-regions comprises:
calculating a correlation coefficient between the first sub-regions and each of the second sub-regions according to a gray value corresponding to each of the pixel points comprised in the first sub-regions and the gray value corresponding to each of the pixel points comprised in each of the second sub-regions; and
determining the second sub-regions corresponding to a maximum correlation coefficient among the plurality of correlation coefficients as the target second sub-region corresponding to the first sub-region.

7. The method according to claim 1, wherein the determining the acid-etching speed of core glass corresponding to the sample microchannel plate blank according to the target velocity value and the preset data table comprises:
matching the target velocity value with the plurality of preset motion velocity intervals; and
determining the acid-etching speed of core glass corresponding to the preset motion velocity intervals with successful matching as the acid-etching speed of core glass corresponding to the sample microchannel plate blank.

8. An apparatus for detecting an acid-etching speed of core glass, comprising:
an acquisition unit, configured to obtain an initial end face image and an acid-etched end face image sequence corresponding to a sample microchannel plate blank, wherein the initial end face image is an image obtained by photographing a target region through a photographing device after irradiating the sample microchannel plate blank with a target light source, and the acid-etched end face image sequence comprises a plurality of acid-etched end face images, and the plurality of acid-etched end face images are sequence of images obtained by photographing the target region through the photographing device after irradiating the sample microchannel plate blank with the target light source and acid-etching the target region with an acid solution;
an interception unit, configured to select a plurality of target microholes in the initial end face image, and intercepting a microhole acid-etching image sequence corresponding to each of the target microholes from the plurality of acid-etched end face images according to position coordinates corresponding to each of the target microholes, wherein the position coordinates corresponding to the target microholes are configured to indicate positions of the target microholes in the initial end face image, and the microhole acid-etching image sequence corresponding to the target microholes comprises a plurality of microhole acid-etching images corresponding to the target microholes;
a first determination unit, configured to determine a plurality of in-plane velocity fields corresponding to each of the target microholes based on a preset digital speckle correlation algorithm and the plurality of microhole acid-etching images corresponding to each of the target microholes;
a second determination unit, configured to determine a maximum velocity value in the plurality of in-plane velocity fields as a target velocity value corresponding to the sample microchannel plate blank; and
a third determination unit, configured to determine the acid-etching speed of core glass corresponding to the sample microchannel plate blank according to the target velocity value and a preset data table, wherein the preset data table comprises a plurality of preset motion velocity intervals and the acid-etching speed of core glass corresponding to each of the preset motion velocity intervals.

9. A storage medium, comprising a stored program, wherein when the program runs, the program controls the apparatus on which the storage medium is located to execute the method for detecting the acid-etching speed of core glass as claimed in claim 1.

10. A device for detecting the acid-etching speed of core glass, comprising a storage medium; and one or more processors, wherein the storage medium is coupled to the processors, and the processors are configured to execute program instructions stored in the storage medium; when the program instructions run, the method for detecting the acid-etching speed of core glass according to claim 1 is executed.
